(19) United States
(12) Patent Application Publication
(10) Pub. No.: US 2023/0183144 A1
(43) Pub. Date: Jun. 15, 2023

(54) BIO-NITROGEN FERTILIZER FORMULATION FOR ORGANIC AND SUSTAINABLE FARMING

(71) Applicant: Basavaraj Girennavar, Doddaballapura-Tq, Bengaluru Rural (IN)

(72) Inventors: Basavaraj GIRENNAVAR, Bengaluru Rural (IN); Amitha GANAPATHY B, Kodagu (IN)

(21) Appl. No.: 17/924,534

(22) PCT Filed: Jul. 19, 2020
(86) PCT No.: PCT/IB2020/056784

§ 371 Date: Nov. 10, 2022

(30) Foreign Application Priority Data
May 10, 2020 (IN) 202041019741

(51) Int. Cl. C05F 11/08; C05C 11/00; C05D 9/00; C05G 5/12

(52) U.S. Cl. CPC C05F 11/08; C05C 11/00; C05D 9/00; C05G 5/12

(57) ABSTRACT

The present invention relates to the Bio-Nitrogen fertilizer formulation to fix the nitrogen from multiple sources for organic and sustainable farming. It particularly relates to the Bio-Nitrogen fertilizer formulation which reduces the use of chemical fertilizer and increase nutrients use efficiency and nitrogen bio-availability for better crop productivity and sustainable agriculture along with increasing the crop nutrition, crop productivity and soil fertility. It specifically relates to the Bio-Nitrogen fertilizer formulation containing nitrogen fixers from multiple sources such as Azotobacter sp., Azospirillum sp., Rhizobium sp., and Gluconacetobater diazotrophicus. The invention also relates to the process for preparation of the Bio-Nitrogen fertilizer formulation to fix the nitrogen from multiple sources for organic and sustainable farming. The invention further relates to the method for management of plant growth or crops by using Bio-Nitrogen fertilizer formulation with full of life for better crop productivity and sustainable agriculture along with increasing the crop nutrition, crop productivity and soil fertility.

### FIELD OF THE INVENTION

The present invention relates to the Bio-Nitrogen fertilizer formulation to fix the nitrogen from multiple sources for organic and sustainable farming. It particularly relates to the Bio-Nitrogen fertilizer formulation which reduces the use of chemical fertilizer and increase nutrients use efficiency and nitrogen bio-availability for better crop productivity and sustainable agriculture along with increasing the crop nutrition, crop productivity and soil fertility. It specifically relates to the Bio-Nitrogen fertilizer formulation containing nitrogen fixers from multiple sources such as Azotobacter sp., Azospirillum sp., Rhizobium sp., and Gluconacetobater diazotrophicus. The invention also relates to the process for preparation of the Bio-Nitrogen fertilizer formulation to fix the nitrogen from multiple sources for organic and sustainable farming. The invention further relates to the method for management of plant growth or crops by using Bio-Nitrogen fertilizer formulation with full of Nitrogen fixers for better crop productivity and sustainable agriculture along with increasing the crop nutrition, crop productivity and soil fertility.

### BACKGROUND OF THE INVENTION

Nitrogen is an essential element required for successful plant growth. Although inorganic nitrogen compounds (i.e., NH₄⁺, NO₂⁻, and NO₃⁻) account for less than 5% of the total nitrogen in soil, they are the main form of the element absorbed by most plants. Healthy plants often contain 3 to 4 percent nitrogen in their above-ground tissues. This is a much higher concentration compared to other nutrients. Nitrogen is so vital because it is a major component of chlorophyll also an essential constituent of protein. It is a significant component of nucleic acids such as DNA, the genetic material that allows cells (and eventually whole plants) to grow and reproduce.

Nitrogen plays a most important role in various physiological processes. It imparts dark-green color in plants, promotes leaves, stem and other vegetative part's growth and development. Moreover, it also stimulates root growth. Nitrogen produce rapid early growth, improve fruit quality, enhances the growth of leafy vegetables, increases protein content of fodder crops; It encourages the uptake and utilization of other nutrients including potassium, phosphorous and controls overall growth of plant.

The long-term effect of excess application of Nitrogenous chemical fertilizers often results in undesirable consequences of degradation of soil, crop quality and overall ecosystem. Nitrogenous chemical fertilizers applied in excess of crop demand is lost through volatilization, denitrification and leaching. N leaching in ground water, and emissions of nitrous oxide (N₂O), a potent greenhouse gas that contributes to global warming Long-term application of ammonia-based N fertilizers, such as urea, has increased soil acidity which rendered to soil infertility where crops fail to respond with further application of N fertilizers. In the soil, too much nitrogen also creates an imbalance of nutrients that causes a depletion of other important minerals such as calcium, phosphorus and magnesium. When the nitrogen abundance reduces important minerals, toxic elements such as aluminum can proliferate and harm plants as well as fish in rivers. Chemical nitrogenous fertilizers application should be invariably balanced not only with P and K but also with deficient secondary and micronutrients.

Our atmosphere has 78% nitrogen gas. The atmospheric nitrogen cannot be taken directly by plants and animals. Certain Soil bacteria (Azotabacter Sp., Azospirillium Sp. Rhizobium sp.) and blue green algae present in the soil fix nitrogen from the atmosphere and convert into compounds of nitrogen. Once nitrogen is converted into these usable compounds, it can be utilized by plants from the soil through their root system there by we can reduce excessive application of chemical fertilizer. More efforts to increase the efficiency of nitrogen fertilizer use through modifications or use of inhibitors of biological processes as well as better management of rates, timing, and incorporation are needed to ensure increased food production while conserving natural resources.

There are several prior arts which reported the role of organic approaches in nitrogen fixation for crop production and sustainable agriculture and the important ones include G. P. Brahmaprakash and Pramod Kumar Sahu, Journal of the Indian Institute of Science VOL 92:1 January-March 2012; Dr. Pallabi Mishra and Dr. Debiprasad Dash, Consilience: The Journal of Sustainable Development, Vol. 11, Iss. 1 (2014), Pp. 41-61; Sandra Stamenković Stojanović, Ivana Karabegović, Vladimir Beškoski, Nada Nikolić and Miodrag Lazić, Hem. Ind. 73 (3) 169-182 (2019); Manashi Barman, Srijita Paul, Aditi Guha Choudhury, Pinaki Roy and Jahnavi Sen, Int. J. Curr. Microbiol. App. Sci (2017) 6(11): 1177-1186; Rakesh Kumar, Narendra Kumawat and Yogesh Kumar Sahu, Popular Kheti, Volume-5, Issue-4 (October-December), 2017; Swapna Latha Aggan, Sch. Acad. J. Pharm., 2013; 2(4):327-332; Itelima J U, Bang W J, Onyimba I A, A review: biofertilizer; a key player in enhancing soil fertility and crop productivity. J Microbiol Biotechnol Rep. 2018; 2(1):22-28; S. S. Sheraz Mandi, G. I. Hassan, S. A. Samoon, H. A. Rather, Showkat A. Dar5 and B. Zehra, Bio-fertilizers in Organic Agriculture. J Phytol 2/10 (2010) 42-54; Naveen Kumar Arora, Maya Verma, and Jitendra Mishra, S. Mehnaz (ed.), Rhizotrophs: Plant Growth Promotion to Bioremediation, Microorganisms for Sustainability 2, DOI 10.1007/978-981-10-4862-3_4; Deepak Bhardwaj, Mohammad Wahid Ansari, Ranjan Kumar Sahoo and Narendra Tuteja, Microbial Cell Factories 2014, 13:66; Satinder Kaur Brar, Saurabh Jyoti Sarma and Emna Chaabouni, J Biofertil Biopestici 2012, 3:5; Deepshikha Thakur, Rajesh Kaushal and Vineet Shyam, Agri. Review, 35 (3): 159-171, 2014; Sudhanshu Verma, Abhishek Singh, Swati Swayamprabha Pradhan, R. K. Singh and J. P. Singh, Int. J. Curr. Microbiol. App. Sci (2017) 6(5): 648-665.

The patents or patent applications of interest which reported on the biofertilizer for nitrogen fixation and their compositions or formulations include PCT application publication no. WO 2017/042833 A1 discloses a bio-fertilizer composition including at least one micro-biological entity selected from the group consisting of bacteria, fungi, and combinations thereof; and a polymeric microgel which can promote the growth of plants, improve seed germination, increase the flowering rate, flowering quality, or improve crop yield and quality after application of said bio-fertilizer directly to the soil or in a natural or artificial substrate or as a foliar spray on the plant. The disclosure also relates to a process for preparation of a bio-fertilizer composition.

PCT application publication no. WO 2011/154960 A1 discloses materials and methods for providing or enhancing nitrogen fixation in plants from pure culture bacteria like Azotobacter chrococcum or Azotobacter vinelandii or Acetobacter xylinum or Gluconacetobacter diazotrophicus or Azospirillum lipoferum that fixes the atmospheric nitrogen from air and makes it available to plants. It also increases efficiency of chemical fertilizer.

PCT application publication no. WO 2012/093374 A1 relates to immobilizing, culturing and granulating live microorganisms on solid carriers. More particularly the invention relates to a method for the preparation of fertilizers comprising the steps of applying soil bacteria maintained in liquid culture medium onto a solid carrier; increasing the oxygen level in the environment of the carrier by gas injection; maintaining the support at a predetermined temperature to allow the proliferation of the soil bacteria; drying the fertilizer to a predetermined humidity by controlling the mixing and gas injection; and optionally granulating the product. The invention also relates to the fertilizer obtained by this method and containing at least 10⁹ cell/g soil bacteria. The soil bacteria are selected from the group consisting of Azospirillum brasilense ssp. SW51 (NCAIM IPI B 001293); Azotobacter vinelandii ssp. M657 (NCAIM IPI B 001292); Pseudomonas fluoresceins var. SW11 (NCAIM IPI B 001296); Bacillus polymyxa var. SW17 (NCAIM IPI B 001295); Bacillus megaterium var. M326 (NCAIM IPI B 001291), Micrococcus roseus sp. A21 (NCAIM IPI B 001294); Azospirillum lipoferum (AL); Bacillus circulans (B. cir.) and/or Streptomyces albus var. 0003 LP (NCAIM IPI B 001301).

PCT application publication no. WO 2014/163471 A1 discloses the use of a biofertilizer product based on an Azospirillum strain having the capacity to fix atmospheric nitrogen. This strain has been noted for its ability to stimulate the assimilation of nutritional elements and increase crop yields. The invention described in the patent also concerns the formulation method which was included from the outset in the mass production of the bacterial strain. Tests have been performed both on the stability of the strain in the product and on the efficiency thereof in improving crop yields.

PCT application publication no. WO 2003/016241 A1 discloses the product(s) containing alive micro-organism(s) suitable for soil treatment, micro-organisms multiplying under different climatic and natural circumstances, as well as the procedure for the production of the products, furthermore procedure for the treatment of the soil and plants with the products. More detailed, the invention relates to a procedure for preparing the products from any of the micro-organisms specified below, or from the mixture thereof. Furthermore, the invention relates to a procedure for the creation of the cultures of the micro-organisms to be used. Subject of the invention are the micro-organisms themselves, as well. More detailed, the invention relates to a procedure for the treatment of the soil and the plants with a product containing at least one of the micro-organisms Azospirillum brasilense ssp. SW51 (NCAIM/P/B 001293), Azotobacter vinelandii spp. M657 (NCAIM/P/B 001291), Pseudomonas fluorescens var. SW11 (NCAIM/P/B 001296), Bacillus polymyxa var. SW17 (NCAIM/P/B 001295/, Bacillus megaterium var. M326 (NCAIM/P/B 001301/-, furthermore the products multiplying and existing in the environment of the plant in question, containing the listed micro-organisms and their production.

PCT application no. WO 1984/001686 A1 discloses the bacteria of Azospirillum brasilense or lipoferum having enhanced pectinolytic activity relative to wild type Azospirillum are useful as biofertilizers for cereal crops. Presently preferred is A. brasilense strain ATCC No. 39199. A. brasilense strains having both enhanced pectinolytic activity and resistance to pesticides such as fungicides and herbicides are particularly useful. Presently preferred is ATCC No. 39200. Also, A. brasilense strains having resistance to pesticides are useful as biofertilizers including presently preferred strain ATCC No. 39201. Effective biofertilizing amounts of one or more of these strains may be incorporated into or applied onto soil in which cereals are grown directly, or in admixture with a suitable carrier, such as peat, or as a seed coating.

U.S. Patent application publication no. US 2007/0068072 A1 discloses Biological nitrogen fixation is a very important process for plant growth. Biological nitrogen fixation is performed naturally by a number of different microorganisms including plant growth-promoting rhizobacteria, mycorrhizal fungi, and rhizobia. The present invention discloses novel compositions comprising water soluble polymers, rhizobium and plant-growth promoting rhizobacteria. Uses of the novel composition include treatment of seeds prior to planting and use in soil surrounding roots to improve plant growth and health.

U.S. Pat. No. 9,975,817 B2 discloses the methods of increasing nitrogen fixation in a non-leguminous plant. The methods can comprise exposing the plant to a plurality of bacteria. Each member of the plurality comprises one or more genetic variations introduced into one or more genes or non-coding polynucleotides of the bacteria's nitrogen fixation or assimilation genetic regulatory network, such that the bacteria are capable of fixing atmospheric nitrogen in the presence of exogenous nitrogen. The bacteria are not intergeneric microorganisms. Additionally, the bacteria, in planta, produce 1% or more of the fixed nitrogen in the plant.

Though there are several prior arts which reported for the Biofertilizer and its formulations for crop nutrition, organic and sustainable agriculture but none of the prior arts in the literature reported or disclosed the liquid or powder or granular form of Bio-Nitrogen fertilizer formulation to fix the nitrogen from multiple sources for organic and sustainable farming. Also, the prior arts reported are having the several drawbacks of their own for application in the fields for crop nutrition, crop productivity, organic farming and soil fertility in sustainable agriculture. Thus, there is a need for a development of suitable effective Bio-Nitrogen fertilizer formulation to fix the nitrogen from multiple sources for organic and sustainable farming. Therefore, the present inventors developed the Bio-Nitrogen fertilizer formulation to fix the nitrogen from multiple sources for organic and sustainable farming which reduces the use of chemical fertilizer and increase nutrients use efficiency and helps in bioavailability of Nitrogen for better crop productivity, organic farming and sustainable agriculture.

### OBJECTIVES OF THE INVENTION

The primary object of the invention is to develop Bio-Nitrogen fertilizer formulation to fix the nitrogen from multiple sources for organic farming and sustainable farming.

The particular object of the present invention is to develop Bio-Nitrogen fertilizer formulation to fix the nitrogen from multiple sources for organic and sustainable farming which reduces the use of chemical fertilizer and increase nutrients use efficiency and nitrogen bio-availability for better crop productivity and sustainable agriculture.

The specific object of the present invention is to develop the Bio-Nitrogen fertilizer formulation to fix the nitrogen from multiple sources for organic and sustainable farming in the liquid or powder or granular form containing nitrogen fixing microbes such as Azotobacter sp., Azospirillum sp., Rhizobium sp., and Gluconacetobater diazotrophicus, complex media of amino acids, proteins, salts, minerals and carbohydrates.

The further object of this invention is to provide a natural alternative organic formulation product which increases the nitrogen and other nutrients bio-availability to the plant for better crop productivity and sustainable agriculture.

The further object of this invention is to develop a process for preparation of the Bio-Nitrogen fertilizer formulation to fix the nitrogen from multiple sources for organic and sustainable farming.

The further object of this invention is to develop a method for management of plant growth or crops by using Bio-Nitrogen fertilizer formulation to fix the nitrogen from multiple sources for organic and sustainable farming.

Yet another object is to provide an effective Bio-Nitrogen fertilizer formulation to fix the nitrogen from multiple sources for organic and sustainable farming which is safe and environmentally friendly.

Yet another object is to provide an effective Bio-Nitrogen fertilizer formulation to fix the nitrogen from multiple sources for organic and sustainable farming which improves the crop yield and productivity.

A further object is to provide an eco-friendly Bio-Nitrogen fertilizer formulation to fix the nitrogen from multiple sources for organic and sustainable farming.

A further object is to provide a safe granular or liquid Bio-Nitrogen fertilizer formulation product that does not cause any adverse effects on people.

It is a further object of the present invention to provide Bio-Nitrogen fertilizer formulation product having a longer shelf life.

It is a further object of the present invention to develop Bio-Nitrogen fertilizer formulation which is inexpensive and cost effective.

It is a further object of the present invention to develop Bio-Nitrogen fertilizer formulation product which is easy to use with little technical expertise.

### STATEMENT OF THE INVENTION

A Bio-Nitrogen fertilizer formulation to fix the nitrogen from multiple sources for organic and sustainable farming comprising 15 to 25% by weight combination of nitrogen fixing microorganisms, 40-50% by weight of nitrogen rich carrier materials, 20 to 30% by weight of bentonite along with nutrients, minerals and micronutrient minerals.

The nitrogen fixing microorganisms are selected from group of independently fixing the nitrogen through biological nitrogen fixer which is Azotobacter sp., associative nitrogen fixing with biological association with crop which is Azospirillum sp., symbiotic nitrogen fixing with host crop plant which is Rhizobium sp. and endophytic nitrogen fixer which is Gluconacetobater diazotrophicus.

The amount of combination of nitrogen fixing microorganisms is 15-25% by weight of total formulation at the ratio of each microorganism in the range of 10 to 40% (w/w) for powder formulation and 10⁵ to 10⁹ CFU/gram or CFU/ml for granular and liquid formulation.

The nitrogen rich carrier materials selected is legume or alfalfa crop residue, amino acids and protein hydrolysates, fish meals.

The amount of nitrogen rich carrier materials is 20-30% by weight of total formulation. The amount of bentonite is 20-30% by weight of total formulation.

The nutrients are selected from amino acids, protein, carbohydrates and salts.

The amount of amino acids, protein, carbohydrates and salts is 4-5% by weight of total formulation.

The minerals are selected from Ca, P, Cl, B and Zn at a concentration of 5-10% 2 by weight of total formulation.

The micronutrient minerals are selected from Cu, Mo, Fe, Co and Ni at a concentration of ranging from 5 to 500 PPM by weight of total formulation. These elements are essential for effective biological nitrogen fixation and enhancing the effectiveness.

The formulation is in the form of granular form or powder form or liquid form with partially or fully soluble in water.

The formulation is preferably in the granular form.

A process for preparation of Bio-Nitrogen fertilizer formulation to fix the nitrogen from multiple sources for organic and sustainable farming comprising:
a. mixing of the 40-50% by weight of nitrogen rich carrier material, 20 to 30% by weight of bentonite along with nutrients, minerals and micronutrient minerals by blending them properly to form the uniform mixture;
b. then to the above mixture at step (a) is mixed with 15 to 25% by weight of culture of combination of nitrogen fixing microorganisms;
c. then the mixture formed in the step (b) is subjected for granulation to form the granules;
d. then the granules formed at step (c) are subjected for drying at low temperature; and
e. after that, the granules are dried to form as Bio-Nitrogen fertilizer formulation to fix the nitrogen from multiple sources for organic and sustainable farming.

### BRIEF DESCRIPTION OF THE DRAWINGS/FIGURES

FIG. 1 Effect of different Bio-Nitrogen fertilizer formulation on growth attributes of Paddy crop

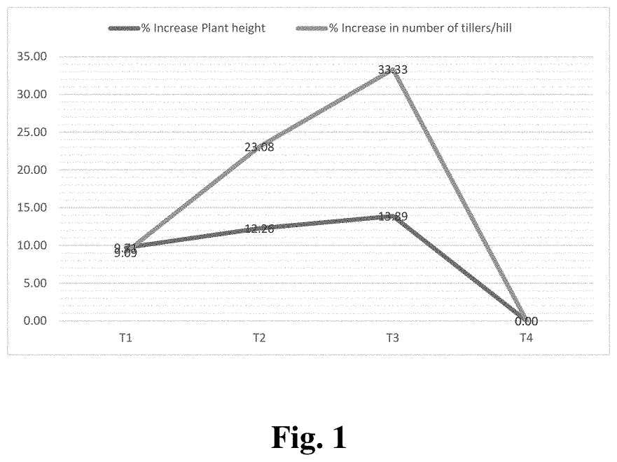

FIG. 2 Effect of different Bio-Nitrogen fertilizer formulation on yield attributes of Paddy crop

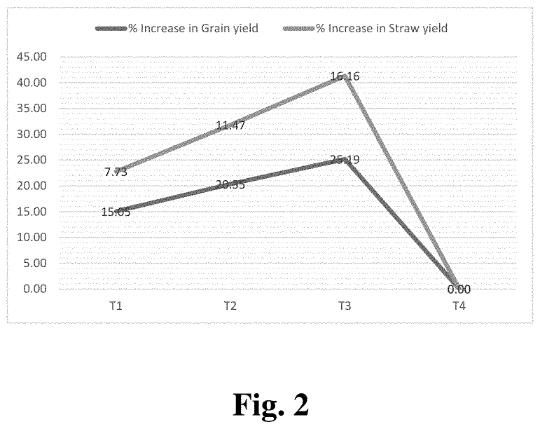

### DETAILED DESCRIPTION OF THE INVENTION

The present invention relates to the Bio-Nitrogen fertilizer formulation to fix the nitrogen from multiple sources for organic and sustainable farming. It particularly relates to the Bio-Nitrogen fertilizer formulation which reduces the use of chemical fertilizer and increase nutrients use efficiency and nitrogen bio-availability for better crop productivity and sustainable agriculture along with increasing the crop nutrition, crop productivity and soil fertility. It specifically relates to the Bio-Nitrogen fertilizer formulation containing nitrogen fixers from multiple sources such as Azotobacter sp., Azospirillum sp., Rhizobium sp., and Gluconacetobater diazotrophicus. The invention also relates to the process for preparation of the Bio-Nitrogen fertilizer formulation to fix the nitrogen from multiple sources for organic and sustainable farming. The invention further relates to the method for management of plant growth or crops by using Bio-Nitrogen fertilizer formulation with full of life for better crop productivity and sustainable agriculture along with increasing the crop nutrition, crop productivity and soil fertility.
1. Formulation containing multiple nitrogen fixing organisms with compatibility and functionality to provide nitrogen by.
   Independently fixing the nitrogen through biological nitrogen fixer such as Azotobacter sp.
   Associative nitrogen fixing with biological association with crop such as Azospirillum sp.
   Symbiotic nitrogen fixing with host crop plant such as Rhizobium sp.
   Endophytic nitrogen fixer such as Gluconacetobater diazotrophicus.
2. Formulation enriched with nitrogen fixing essential micro and trace elements such as Cu, Mo, Fe, Co and Ni to enhance the establishment and performance of the biological nitrogen fixation system.
3. Formulation enriched with naturally occurring minerals aiding in biological nitrogen fixation such as Ca, P, Cl, B and Zn as part of the carrier material to enhance to nitrogen fixing efficacy and nitrogen bio-availability.
4. Formulation containing pre-biotic media for the nitrogen fixing above said microbes.
5. Formulation fortified with nitrogen rich carrier materials such as legume or more specifically alfalfa crop residue, amino acids and protein hydrolysates, fish meals etc.
6. Formulation containing soluble or partially soluble organic carrier material to hold and sustain the formulation for longer period of self-life.
7. Formulation either in granular, powder or liquid forms either partially or fully soluble in water.

### Bio-Nitrogen: Preparation Details (Instance of Artwork/Formulation in Use).

### Working Example

### Raw Material:

1. Bio-fertilizer liquid formulation: (prepared with CFU of 5×10\hat{ }9): 15 to 25% (w/w)
   a) Azotobacter sp. preferably Azotobacter chroococcum
   b) Azospirillum sp. preferably Azospirillum brasilense
   c) Rhizobium sp. preferably Rhizobium leguminosarum
   d) Gluconacetobater diazotrophicus
   All above microbe will be mixed in the range 10 to 40% of each culture.
2. Media components (amino acids, Protein hydrolysate, carbohydrates, Salt): 4-5% (w/w)
   The media components in the proportion of:
      Amino acids: 20-30%
      Protein hydrolysate: 30-50%
      Salt: 20-30%
3. Nitrogen rich carrier materials such as legume or more specifically alfalfa crop residue, amino acids and protein hydrolysates, fish meals: 20-30% (w/w)
   legume or more specifically alfalfa crop residue: 30-40%
   Amino acids and protein hydrolysates: 10-20%
   Fish meals: 10-20%
4. Carrier material along with natural occurring minerals (Ca, P, Cl, B and Zn): 5-10% (w/w)
   Ca: 25-50%
   P: 25-50%
   Cl: 1-5%
   Zn: 5-10%
   B: 1-5%
5. Nitrogen fixing essential micro and trace elements (Cu, Mo, Fe, Co and Ni): 2-3% (w/w)
   Nitrogen fixation aiding elements such as Fe, Cu, Mo, Co and Ni in the range which enhances the process of biological nitrogen fixation by enhancing the enzyme activity which are critical to the vital process of diazotrophic micro-organisms. Composition of each of the elements shall be as in the table of the final formulation.

TABLE 1
Nitrogen fixing essential micro and trace elements

| Sl. No. | Element | Composition (in PPM) |
|---|---|---|
| 1 | Fe | 400 to 500 ppm |
| 2 | Cu | 200 to 250 ppm |
| 3 | Mo | 25 to 50 ppm |
| 4 | Co | 20 to 30 ppm |
| 5 | Ni | 5 to 10 ppm |

6. Bentonite: 20-30% (w/w)

### Procedure:

1. Mix nitrogen rich carrier material, media component, mineral matters and bentonite, according to the proposition mentioned in the composition and blend it properly for 15 minutes.
2. Then above mixture is mixed with the 15-25% biofertilizer liquid formulation to achieve optimal condition for granulation process.
3. The mixed powder is fed into granulator.
4. During process of granulation, spray 1 to 5% of biofertilizer liquid formulation for proper granulation.
5. Dry the granules low temperature (40-60 degree centigrade), until it dries completely. Keep the CFU to the >95% safe, live and efficacious in the process of drying.
6. Dried granules are sieved and packed in various size bags.

TABLE 2
Effect of different Bio-Nitrogen fertilizer formulation on growth attributes of Paddy crop

| | | | | | | % |
|---|---|---|---|---|---|---|
| | | | | Number | % | Increase |
| | | | Plant | of | Increase | in number |
| Treatment | | | height | tillers/ | Plant | of tillers/ |
| code | Treatment details | Dosage | (cm) | hill | height | hill |
| T1 | Bio-fertilizer: Azospirillum sp | 10 | 103.00 | 11.00 | 9.71 | 9.09 |
| | | kg/acre | | | | |
| T2 | Bio-fertilizer Consortia (Bio-N, Bio-P | 10 | 106.00 | 13.00 | 12.26 | 23.08 |
| | and Bio-K) | kg/acre | | | | |
| T3 | Bio-Nitrogen fertilizer formulation | 10 | 108.00 | 15.00 | 13.89 | 33.33 |
| | (Azotobacter sp., + Azospirillum sp., + | kg/acre | | | | |
| | Rhizobium sp., + Gluconacetobater | | | | | |
| | diazotrophicus + Media components + | | | | | |
| | Nitrogen rich carrier material + Plant | | | | | |
| | micro-nutrient mineral media) | | | | | |
| T4 | Control | | 93.00 | 10.00 | 0.00 | 0.00 |

TABLE 3
Effect of different Bio-Nitrogen fertilizer formulation on yield attributes of Paddy crop

| | | | Grain | | % | % |
|---|---|---|---|---|---|---|
| | | | yield | Straw | Increase | Increase |
| Treatment | | | (Qt/ | yield | in Grain | in Straw |
| code | Treatment details | Dosage | acre | (Qt/acre) | yield | yield |
| T1 | Bio-fertilizer: Azospirillum sp | 10 | 23.78 | 32.62 | 15.05 | 7.73 |
| | | kg/acre | | | | |
| T2 | Bio-fertilizer Consortia (Bio-N, Bio- | 10 | 25.36 | 34.00 | 20.35 | 11.47 |
| | P and Bio-K) | kg/acre | | | | |
| T3 | Bio-Nitrogen fertilizer formulation | 10 | 27.00 | 35.90 | 25.19 | 16.16 |
| | (Azotobacter sp., + Azospirillum sp., + | kg/acre | | | | |
| | Rhizobium sp., + Gluconacetobater | | | | | |
| | diazotrophicus + Media components + | | | | | |
| | Nitrogen rich carrier material + Plant | | | | | |
| | micro-nutrient mineral media) | | | | | |
| T4 | Control | | 20.20 | 30.10 | 0.00 | 0.00 |

1. A Bio-Nitrogen fertilizer formulation to fix the nitrogen from multiple sources for organic and sustainable farming comprising 15 to 25% by weight combination of nitrogen fixing microorganisms, cultures 20-30% by weight of nitrogen rich carrier materials, 20 to 30% by weight of bentonite along with nutrients, minerals and micronutrient minerals.

2. The Bio-Nitrogen fertilizer formulation to fix the nitrogen from multiple sources for organic and sustainable farming as claimed in claim 1 wherein the nitrogen fixing microorganisms are selected from group of independently fixing the nitrogen through biological nitrogen fixer which is Azotobacter sp., associative nitrogen fixing with biological association with crop which is Azospirillum sp., symbiotic nitrogen fixing with host crop plant which is Rhizobium sp. and endophytic nitrogen fixer which is Gluconacetobater diazotrophicus.

3. The Bio-Nitrogen fertilizer formulation to fix the nitrogen from multiple sources for organic and sustainable farming as claimed in claim 1 wherein the amount of combination of nitrogen fixing microorganisms is 15-25% by weight of total formulation at the ratio of each microorganism in the range of 10 to 40% (w/w).

4. The Bio-Nitrogen fertilizer formulation to fix the nitrogen from multiple sources for organic and sustainable farming as claimed in claim 1 wherein the nitrogen rich carrier materials selected is legume or alfalfa crop residue, amino acids and protein hydrolysates, fish meals.

5. The Bio-Nitrogen fertilizer formulation to fix the nitrogen from multiple sources for organic and sustainable farming as claimed in claim 1 wherein the amount of nitrogen rich carrier materials is 20-30% by weight of total formulation.

6. The Bio-Nitrogen fertilizer formulation to fix the nitrogen from multiple sources for organic and sustainable farming as claimed in claim 1 wherein the amount of bentonite is 20-30% by weight of total formulation.

7. The Bio-Nitrogen fertilizer formulation to fix the nitrogen from multiple sources for organic and sustainable farming as claimed in claim 1 wherein the nutrients are selected from amino acids, protein hydrolysates, carbohydrates and salts.

8. The Bio-Nitrogen fertilizer formulation to fix the nitrogen from multiple sources for organic and sustainable farming as claimed in claim 7 wherein the amount of amino acids, protein, carbohydrates and salts is 4-5% by weight of total formulation.

9. The Bio-Nitrogen fertilizer formulation to fix the nitrogen from multiple sources for organic and sustainable farming as claimed in claim 1 wherein the minerals are selected from Ca, P, Cl, B and Zn at a concentration of 5-10% by weight of total formulation.

10. The Bio-Nitrogen fertilizer formulation to fix the nitrogen from multiple sources for organic and sustainable farming as claimed in claim 1 wherein the elements essential for biological nitrogen fixation are selected from Cu, Mo, Fe, Co and Ni at a concentration ranging from 5-500 PPM by weight of total formulation.

11. The Bio-Nitrogen fertilizer formulation to fix the nitrogen from multiple sources for organic and sustainable farming as claimed in claim 1 wherein the formulation is in the form of granular form or powder form or liquid form with partially or fully soluble in water.

12. The Bio-Nitrogen fertilizer formulation to fix the nitrogen from multiple sources for organic and sustainable farming as claimed in claim 11 wherein the formulation is in the granular form.

13. A process for preparation of Bio-Nitrogen fertilizer formulation to fix the nitrogen from multiple sources for organic and sustainable farming comprising:
a. mixing of the 40-50% by weight of nitrogen rich carrier material, 20 to 30% by weight of bentonite along with nutrients, minerals and micronutrient minerals by blending them properly to form the uniform mixture;
b. then to the above mixture at step (a) is mixed with 15 to 25% by weight of culture of combination of nitrogen fixing microorganisms;
c. then the mixture formed in the step (b) is subjected for granulation to form the granules;
d. then the granules formed at step (c) are subjected for drying at low temperature; and
e. after that, the granules are dried to form as Bio-Nitrogen fertilizer formulation to fix the nitrogen from multiple sources for organic and sustainable farming.

14. The process for preparation of Bio-Nitrogen fertilizer formulation to fix the nitrogen from multiple sources for organic and sustainable farming as claimed in claim 13 wherein the amount of culture of combination of nitrogen fixing microorganisms is 15% by weight of total formulation at the ratio of each microorganism in the range of 10 to 40% (w/w).

15. The process for preparation of Bio-Nitrogen fertilizer formulation to fix the nitrogen from multiple sources for organic and sustainable farming as claimed in claim 13 wherein the nitrogen fixing microorganisms are selected from group of independently fixing the nitrogen through biological nitrogen fixer which is Azotobacter sp., associative nitrogen fixing with biological association with crop which is Azospirillum sp., symbiotic nitrogen fixing with host crop plant which is Rhizobium sp. and endophytic nitrogen fixer which is Gluconacetobater diazotrophicus.

16. The process for preparation of Bio-Nitrogen fertilizer formulation to fix the nitrogen from multiple sources for organic and sustainable farming as claimed in claim 13 wherein the amount of nitrogen rich carrier material is 20-30% by weight of total formulation.

17. The process for preparation of Bio-Nitrogen fertilizer formulation to fix the nitrogen from multiple sources for organic and sustainable farming as claimed in claim 13 wherein the amount of bentonite is 20-30% by weight of total formulation.

18. The process for preparation of Bio-Nitrogen fertilizer formulation to fix the nitrogen from multiple sources for organic and sustainable farming as claimed in claim 13 wherein the nutrients are selected from amino acids, carbohydrates, protein hydrolysate and salts at the concentration of 4-5% by weight of total formulation.

19. The process for preparation of Bio-Nitrogen fertilizer formulation to fix the nitrogen from multiple sources for organic and sustainable farming as claimed in claim 13 wherein the amount of micronutrients is 5-10% by weight of total formulation.

20. The process for preparation of Bio-Nitrogen fertilizer formulation to fix the nitrogen from multiple sources for organic and sustainable farming as claimed in claim 13 wherein the amount of elements concentration ranging from 5-500 PPM by weight of total formulation.
